(19) United States
(12) Patent Application Publication
(10) Pub. No.: US 2013/0017699 A1
(43) Pub. Date: Jan. 17, 2013

(54) POWER SUPPLY DEVICE AND POWER SUPPLY SYSTEM

(71) Applicants: HAN-YU LI, Tu-Cheng (TW); NING ZHANG, Shenzhen City (CN); HAI-FENG WU, Shenzhen City (CN)

(72) Inventors: HAN-YU LI, Tu-Cheng (TW); NING ZHANG, Shenzhen City (CN); HAI-FENG WU, Shenzhen City (CN)

(73) Assignees: HON HAI PREICISION INDUSTRY CO., LTD., Tu-Cheng (TW); HONG FU JIN PRECISION INDUSTRY (ShenZhen) CO., LTD., Shenzhen City (CN)

(21) Appl. No.: 13/461,001

(22) Filed: May 1, 2012

(30) Foreign Application Priority Data
Jul. 14, 2011 (CN) 201110196982.2

(51) Int. Cl. H01R 4/60

(52) U.S. Cl. 439/212

(57) ABSTRACT

A power supply device includes a power supply module, a main bus-bar module, an assistant bus-bar module, and a plurality of connectors. The power supply module, for supplying a direct current voltage, includes a positive terminal and a negative terminal for outputting the current voltage. The main bus-bar module includes a first main bus-bar and a second main bus-bar. The first main bus-bar is electronically connected to the positive terminal. The second main bus-bar is electronically connected to the negative terminal. The assistant bus-bar module includes a first assistant bus-bar electronically connected to the second main bus-bar, and a second assistant bus-bar electronically connected to the first main bus-bar. Each connector includes a first pin and a second pin. The first pin is inserted and electronically connected to the first assistant bus-bar. The second pin is inserted and electronically connected to the second assistant bus-bar.

### BACKGROUND

1. Technical Field

The present disclosure relates to power supply devices and power supply systems, and particularly to a power supply device and a power supply systems for a server rack.

2. Description of Related Art

Blade and rack-mounted servers are popular for data center servers. In order to achieve high performance, many rack-mounted servers are clustered in an enclosure. A server rack assembly may include a server rack and a plurality of servers received in the server rack. Each of the plurality of servers is connected to a power supply, and the power supply may include a power transforming module and a power-setting module. Thus, a plurality of power supplies, including a plurality of power transforming modules and a plurality of power-setting modules, are received in the server rack. When the plurality of servers needs maintenance, it can be confusing to service because of the plurality of power transforming modules and a plurality of power-setting modules. Therefore, an improved power supply device and an improved power supply system for a server rack with the power supply device is desirable.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an assembled, isometric view of one embodiment of a power supply system and an electronic device.

FIG. 2 is an assembled, isometric view of an installation wall, a power supply device and the electronic device of FIG. 1.

FIG. 3 is an exploded, isometric view of the installation wall, the power supply device and the electronic device of FIG. 1.

FIG. 4 is an exploded, isometric view of a main bus-bar module and an assistant bus-bar module of the power supply device of FIG. 3.

FIG. 5 is an exploded, isometric view of the main bus-bar module of FIG. 4.

FIG. 6 is an exploded, isometric view of the assistant bus-bar module of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

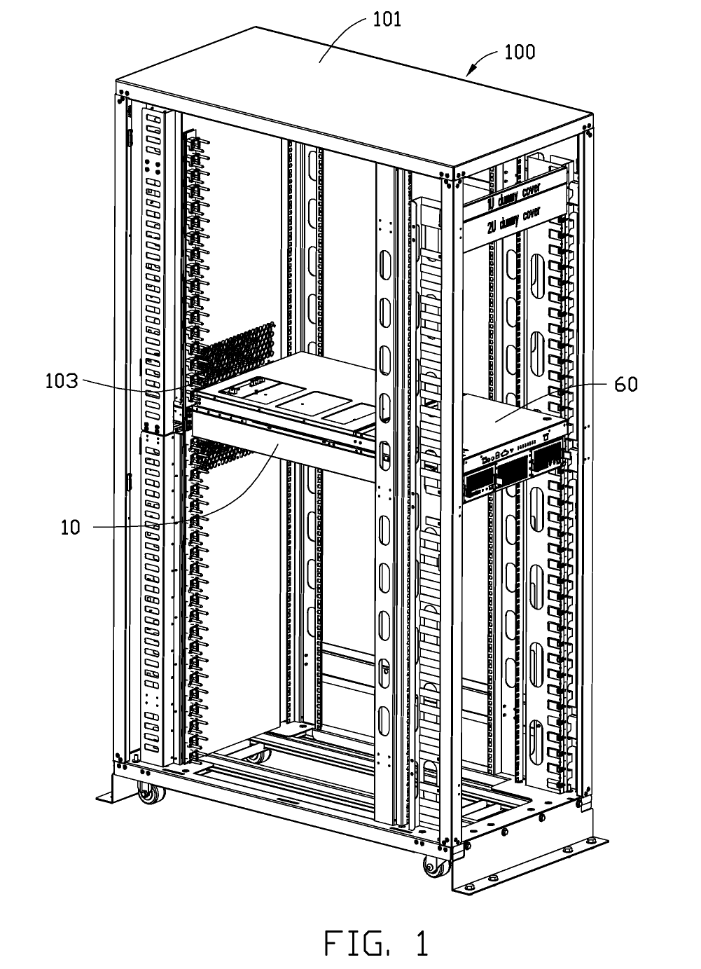

Referring to FIG. 1, a power supply system 100 in accordance with an embodiment includes a frame 101, an installation wall 103 located in the frame 101, a plurality of electronic devices 60 secured to the installation wall 103, and a power supply device secured to the installation wall 103. Each of the plurality of electronic devices 60 has a power connector (not shown). In one embodiment, the frame 101 is a server rack, and each of the plurality of electronic device 60 is a server.

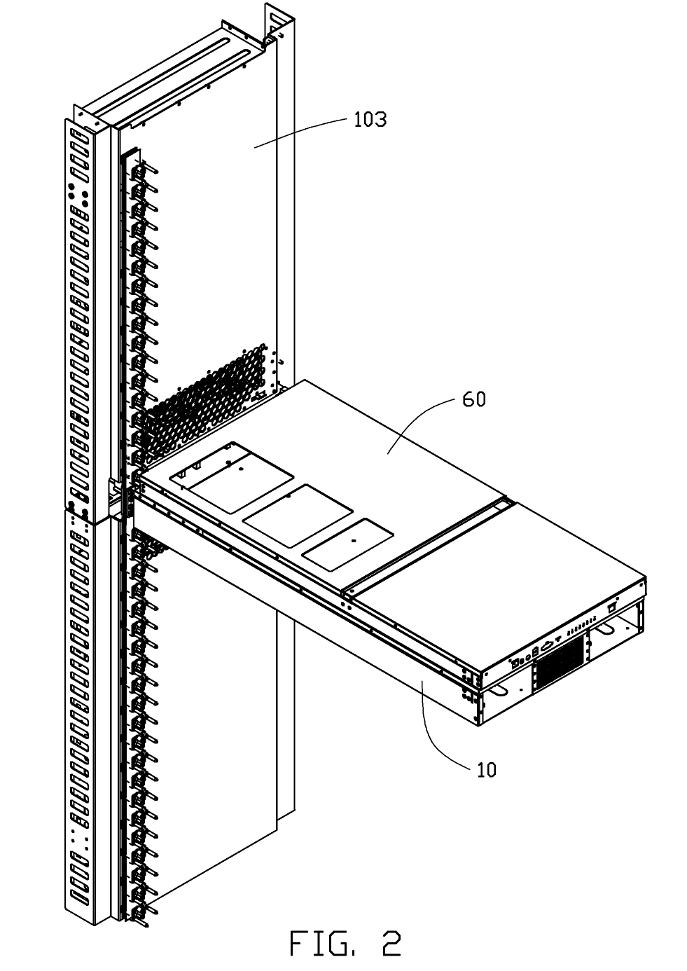

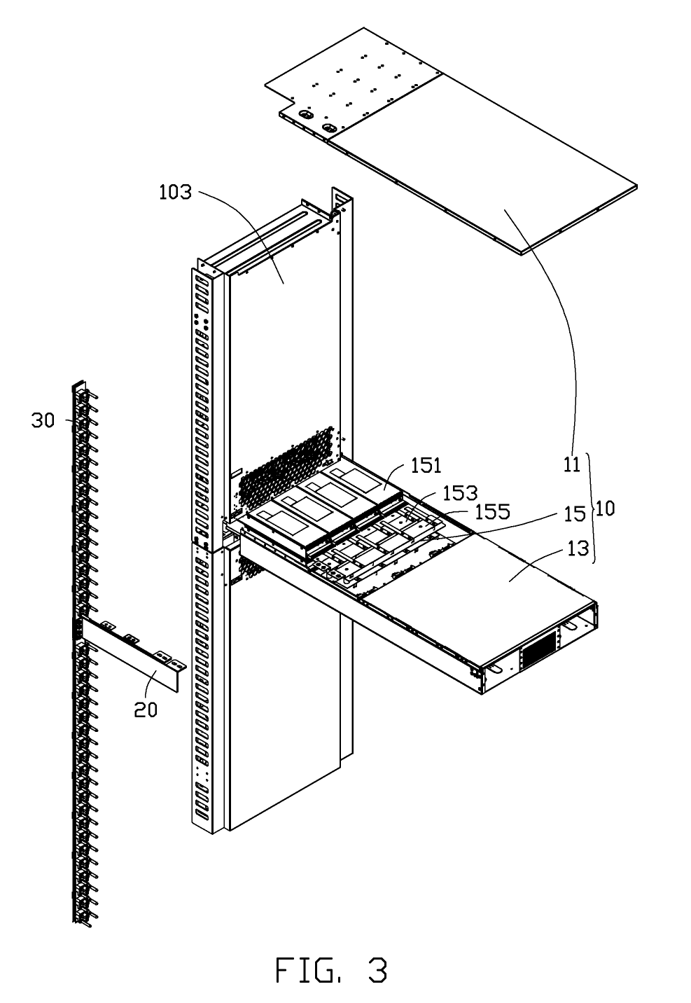

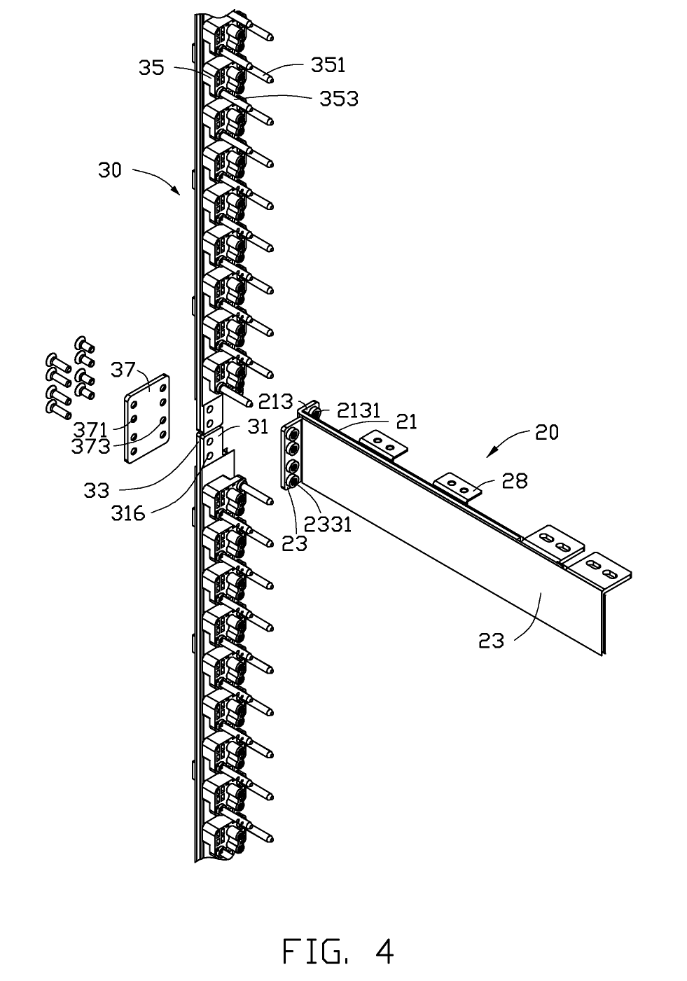

Referring to FIGS. 2-4, the power supply device includes a power supply module 10, a main bus-bar module 20 and an assistant bus-bar module 30.

The power supply module 10 includes a cover 11, a case 13, and a circuit board 15 mounted in the case 13. A plurality of power supplies 151 is secured to the circuit board 15. The plurality of power supplies 151 utilize a parallel redundant power supply mode to transform a 220 volts alternating current voltage to a 12 volts direct current voltage. A first power supply board 153 and a second power supply board 155 are secured to the circuit board 15. The first power supply board 153 and the second power supply board 155 are electronically connected to a positive terminal and to a negative terminal of the plurality of power supplies 151 respectively.

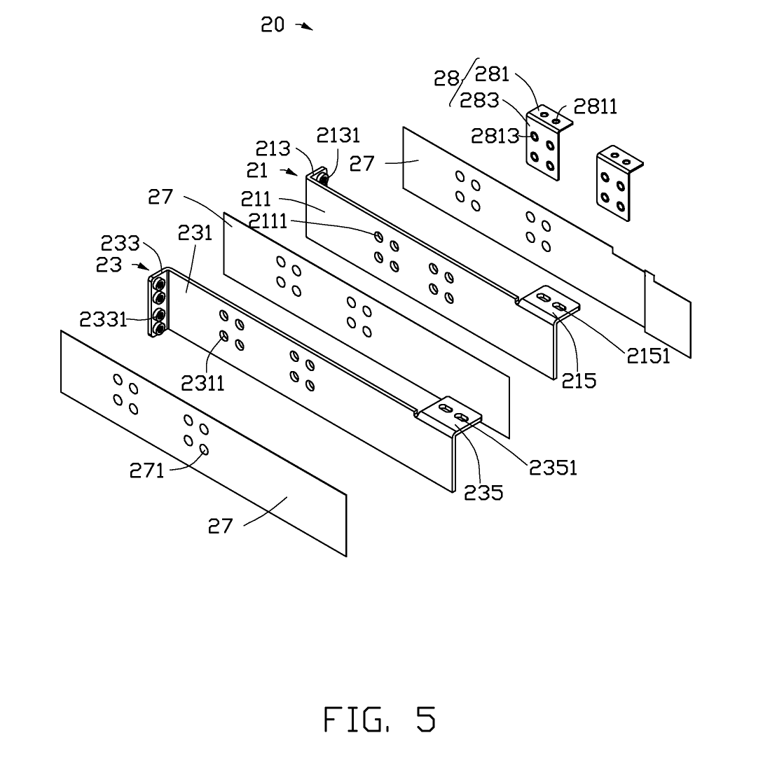

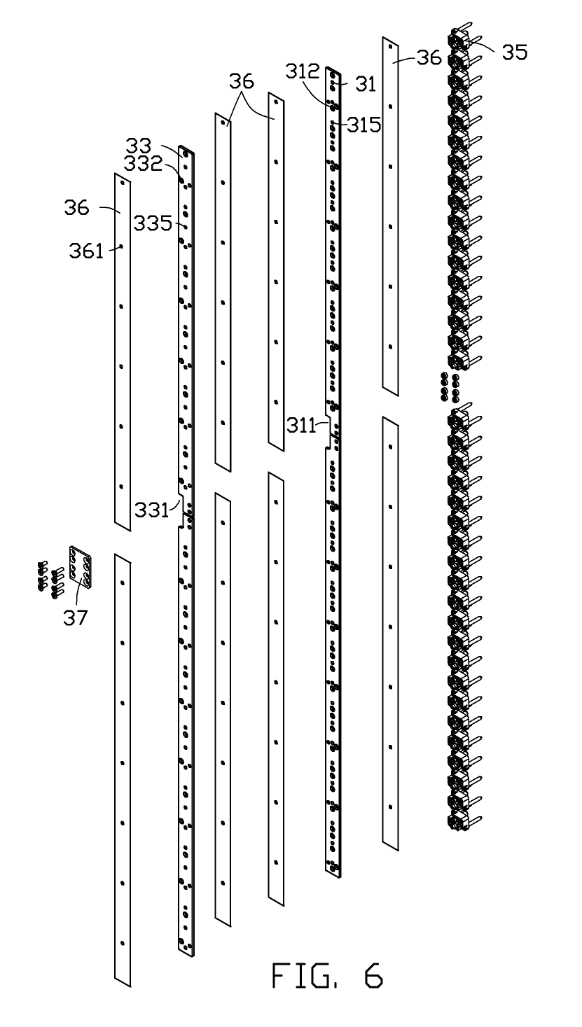

Referring to FIG. 5 and FIG. 6, the main bus-bar module 20 includes a first main bus-bar 21, a second main bus-bar 23, a plurality of first insulating layers 27, and two mounting members 28. The first main bus-bar 21 includes a first body 211, a first guiding piece 213 and a first locking piece 215. The first guiding piece 213 extends from a side edge of the first body 211. The first locking piece 215 extends from a top edge of the first body 211. The first body 211 defines a plurality of first connecting holes 2111. A first insulating cushion (not shown) is secured to an inner surface of each of the plurality of first connecting holes 2111. The first guiding piece 213 defines a plurality of first guiding holes 2131. The first locking piece 215 defines two first locking holes 2151. The second main bus-bar 23 includes a second body 231, a second guiding piece 233 and a second locking piece 235. The second guiding piece 233 extends from a side edge of the second body 231. The second locking piece 235 extends from a top edge of the second body 231. The second body 231 defines a plurality of second connecting holes 2311. A second insulating cushion (not shown) is secured to an inner surface of each of the plurality of second connecting holes 2311. The second guiding piece 233 defines a plurality of second guiding holes 2331. The second locking piece 235 defines two second locking holes 2351. In one embodiment, the first guiding piece 213 and the first locking piece 215 are substantially perpendicular to the first body 211, and the second guiding piece 233 and the second locking piece 235 are substantially perpendicular to the second body 231. Each of the two mounting members 28 includes a mounting piece 281 and a connecting piece 283 connected to the mounting piece 281. In one embodiment, the mounting piece 281 is substantially perpendicular to the connecting piece 283. The mounting piece 281 defines two mounting holes 2811. The connecting piece 283 defines a plurality of connecting holes 2831. The plurality of first insulating layers 27 are adapted to adhere to each side of the first body 211 and the second body 231. Each of the plurality of first insulating layers 27 defines a plurality of connecting holes 271.

In assembly of the main bus-bar module 20, each of the plurality of first insulating layers 27 adheres to each side surface of each of the first body 211 and the second body 231. The first body 211 is moved to be adjacent to the second body 231, and the first connecting hole 2111 is aligned with the second connecting hole 2311. The mounting member 28 is moved to be adjacent to the first body 211, and the connecting piece 283 abuts the first insulating layer 27 of the first body 211. The first connecting hole 2111 and the second connecting hole 2311 are aligned with the connecting hole 271. A locking member (not shown), such as a screw, is inserted into the connecting hole 271, the first connecting hole 2111, and the second connecting hole 2311, to secure the first main bus-bar 21 to the second main bus-bar 23. The first main bus-bar 21 is insulated from the second main bus-bar 23.

The assistant bus-bar module 30 includes a top portion and a bottom portion. Each of the top portion and the bottom portion includes a first assistant bus-bar 31, a second assistant bus-bar 33, a plurality of connectors 35, a plurality of second insulating layers 36, and a positioning piece 37. The first assistant bus-bar 31 defines a plurality of first positioning holes 312 and a plurality of first receiving holes 315. An end of the first assistant bus-bar 31 defines a first cutout 311 and two first installation holes 316. The second assistant bus-bar 33 defines a plurality of second positioning holes 332 corresponding to the plurality of first positioning holes 312, and a plurality of second receiving holes 335 corresponding to the plurality of first receiving holes 315. An end of the second assistant bus-bar 33 defines a second cutout 331 and two second installation holes 336. The second cutout 331 corresponds to the first cutout 311. Each of the two second installation holes 336 corresponds to the first installation holes 316. A second insulating cushion (not shown) is secured in an inner surface of each first positioning hole 312 and each second positioning hole 332. Each connector 35 includes a first pin 351 and a second pin 353. The first pin 351 can be inserted into the first receiving hole 315, and the second pin 353 can be inserted into the second receiving hole 335. The plurality of second insulating layers 36 are adapted to adhere to each side of the first assistant bus-bar 31 and the second assistant bus-bar 33. Each of the plurality of second insulating layers 36 defines a plurality of positioning holes 361. The positioning piece 37 defines a plurality of first locking holes 371 and a plurality of second locking holes 373.

In assembly of the assistant bus-bar module 30, each of the plurality of second insulating layers 36 adheres to each side surface of each of the first assistant bus-bar 31 and the second assistant bus-bar 33. The first cutout 311, the second cutout 331, the first installation hole 316 and the second installation hole 336 are exposed out of the plurality of second insulating layers 36. The first assistant bus-bar 31 is moved to be adjacent to the second assistant bus-bar 33, and the first positioning hole 312 is aligned with the second positioning hole 332 and the positioning hole 361. Another locking member is inserted into the first positioning hole 312, the second positioning hole 332, and the positioning hole 361, to secure the first assistant bus-bar 31 to the second assistant bus-bar 33. Each of the first assistant bus-bar 31 and the second assistant bus-bar 33 is insulated. The first pin 351 is inserted into the first receiving hole 315 and electronically connected to the first assistant bus-bar 31. The second pin 353 is inserted into the second receiving hole 335 and electronically connected to the second assistant bus-bar 33. Each connector 35 is adapted for being inserted and connected to the power connector of the electronic device 60. The plurality of connectors 35 are lined in the second assistant bus-bar 33, and a distance between each two adjacent connectors 35 is substantially equal to a height of the electronic device 60.

In assembly of the power supply device, the case 13 is secured to the installation wall 103. In one embodiment, the power supply module 10 is secured to a center of the installation wall 103. The main bus-bar module 20 is placed in the case 13. and the second main bus-bar 23 is adjacent to a side of the case 13. The first locking piece 215 is secured and electronically connected to the first power supply board 153, and the second locking piece 235 is secured and electronically connected to the second power supply board 155. The assistant bus-bar module 30 abuts the installation wall 103, and each of the plurality of first installation holes 316 is aligned with each of the plurality of second guiding holes 2331. The positioning piece 37 is located between the second assistant bus-bar 33 and the installation wall 103, and each first locking hole 371 is aligned with each first installation hole 316, and each second locking hole 373 is aligned with each first guiding hole 2131. The second main bus-bar 23 is electronically connected to the first assistant bus-bar 31 through a second locking member (not shown), such as a screw, passing through the second guiding hole 2331, the first installation hole 316, and the first locking hole 371. The first main bus-bar 21 is electronically connected to the second assistant bus-bar 33 through another locking member passing through the first guiding hole 2131 and the second locking hole 373. The cover 11 is secured to the case 13 and covers the case 13. The mounting piece 281 is secured to the cover 11.

In use, a voltage difference between the first assistant bus-bar 31 and the second assistant bus-bar 33 is equal to a voltage difference between the first main bus-bar 21 and the second main bus-bar 23. The voltage difference between the first main bus-bar 21 and the second main bus-bar 23 is equal to a voltage difference between the first power supply board 153 and the second power supply board 155, which is 12 volts. Similarly, a voltage difference between the first pin 351 and the second pin 353 of each connector 35 is equal to 12 Volts. Thus, when the electronic device 60 is secured to the power supply system 100, the power connector of the electronic device 60 is electronically connected to each connector 35 directly. In disassembly of the electronic device 60, the electronic device 60 is moved away from the installation wall 103, to disengage the power connector from the connector 35. Thus, the electronic device 60 is removed from the power supply system 100.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the invention to the full extent indicated by the broad general meaning of the terms in which the appended claims are expressed.

What is claimed is:

1. A power supply device, comprising:
a power supply module comprising a positive terminal and a negative terminal, and the positive terminal and the negative terminal adapted to output a direct current voltage;
a main bus-bar module comprising a first main bus-bar and a second main bus-bar, the first main bus-bar is electronically connected to the positive terminal, and the second main bus-bar is electronically connected to the negative terminal;
an assistant bus-bar module comprising a first assistant bus-bar and a second assistant bus-bar, the first assistant bus-bar is electronically connected to the second main bus-bar, and the second assistant bus-bar is electronically connected to the first main bus-bar; and
a plurality of connectors secured to the assistant bus-bar module, and each of the plurality of connectors comprising a first pin and a second pin; the first pin being inserted and electronically connected to the first assistant bus-bar, and the second pin being inserted and electronically connected to the second assistant bus-bar.

2. The power supply device of claim 1, wherein the power supply module further comprises a power supply, a circuit board, a first power supply board, and a second power supply board; the power supply, the first power supply board and the second power supply board are secured to the circuit board; and the power supply is adapted to supply the direct current voltage, the first power supply board is electronically connected to the positive terminal, and the second power supply board is electronically connected to the negative terminal.

3. The power supply device of claim 2, wherein the power supply utilizes a parallel redundant power supply mode to transfer an alternating current voltage to the direct current voltage.

4. The power supply device of claim 1, wherein the plurality of connectors are lined on the second assistant bus-bar, and a distance between each two adjacent of the plurality of connectors is equal.

5. The power supply device of claim 1, wherein an insulating layer is secured to each side surface of each of the first main bus-bar, the second main bus-bar, the first assistant bus-bar, and the second assistant bus-bar.

6. The power supply device of claim 1, wherein the first main bus-bar defines a first connecting hole, the second main bus-bar defines a second connecting hole, and the first connecting hole is aligned with the second connecting hole; the first main bus-bar is secured to the second main bus-bar through the first connecting hole and the second connecting hole; and an insulating cushion is secured to an inner surface of each of the first main bus-bar and the second main bus-bar.

7. The power supply device of claim 2, wherein the first main bus-bar comprises a first body, a first guiding piece, and a first locking piece; the first guiding piece and the first locking piece are located on two opposite sides of the first body; and the first guiding piece and the first locking piece extend from two adjacent edges of the first body.

8. The power supply device of claim 7, wherein the second main bus-bar comprises a second body, a second guiding piece, and a second locking piece; the second guiding piece is located on a first side of the second body, and the second locking piece is located on a second side of the second body that is opposite to the first side; the second guiding piece extends from a first edge of the second body, and the second locking piece extends from a second edge of the second body that is adjacent to the first edge; an extending direction of the second locking piece is same as that of the first locking piece; and an extending direction of the second guiding piece is opposite to that of the first guiding piece.

9. The power supply device of claim 8, wherein the assistant bus-bar module further comprises a positioning piece; the first main bus-bar defines a first cutout, and the second main bus-bar defines a second cutout; the first guiding piece is secured to the second assistant bus-bar and the positioning piece, the second guiding piece is secured to the positioning piece through the first cutout and the second cutout, and the first assistant bus-bar is located between the positioning piece and the second assistant bus-bar.

10. The power supply device of claim 8, wherein the first locking piece is electronically connected to the first power supply board, and the second locking piece is electronically connected to the second power supply board.

11. A power supply system, comprising:
a frame comprising an installation wall;
and a power supply device secured to the installation wall and comprising:
a power supply module comprising a case secured to the installation wall, a positive terminal, and a negative terminal; and the positive terminal and the negative terminal adapted to output a direct current voltage;
a main bus-bar module, received in the case, comprising a first main bus-bar and a second main bus-bar, the first main bus-bar is electronically connected to the positive terminal, and the second main bus-bar is electronically connected to the negative terminal;
an assistant bus-bar module comprising a first assistant bus-bar and a second assistant bus-bar, the first assistant bus-bar is electronically connected to the second main bus-bar, and the second assistant bus-bar is electronically connected to the first main bus-bar; and
a plurality of connectors secured to the assistant bus-bar module, and each of the plurality of connectors comprising a first pin and a second pin; the first pin being inserted and electronically connected to the first assistant bus-bar, and the second pin being inserted and electronically connected to the second assistant bus-bar.

12. The power supply system of claim 11, wherein the power supply module further comprises a power supply, a circuit board, a first power supply board, and a second power supply board; the power supply, the first power supply board and the second power supply board are secured to the circuit board; the power supply supplies the direct current voltage, the first power supply board is electronically connected to the positive terminal, and the second power supply board is electronically connected to the negative terminal.

13. The power supply system of claim 12, wherein the power supply utilizes a parallel redundant power supply mode to transfer an alternating current voltage to the direct current voltage.

14. The power supply system of claim 11, wherein the plurality of connectors are lined on the second assistant bus-bar, and a distance between each two adjacent of the plurality of connectors is equal.

15. The power supply system of claim 11, wherein an insulating layer is secured to each side surface of each of the first main bus-bar, the second main bus-bar, the first assistant bus-bar and the second assistant bus-bar.

16. The power supply system of claim 11, wherein the first main bus-bar defines a first connecting hole, the second main bus-bar defines a second connecting hole, and the first connecting hole is aligned with the second connecting hole; the first main bus-bar is secured to the second main bus-bar through the first connecting hole and the second connecting hole; and an insulating cushion is secured to an inner surface of each of the first main bus-bar and the second main bus-bar.

17. The power supply system of claim 12, wherein the first main bus-bar comprises a first body, a first guiding piece, and a first locking piece; the first guiding piece and the first locking piece are located on two opposite sides of the first body; and the first guiding piece and the first locking piece extend from two adjacent edges of the first body.

18. The power supply system of claim 17, wherein the second main bus-bar comprises a second body, a second guiding piece, and a second locking piece; the second guiding piece is located on a first side of the second body, and the second locking piece is located on a second side of the second body that is opposite to the first side; the second guiding piece extends from a first edge of the second body, and the second locking piece extends from a second edges of the second body that is adjacent to the first edge; an extending direction of the second locking piece is same as that of the first locking piece; and an extending direction of the second guiding piece is opposite to that of the first guiding piece.

19. The power supply system of claim 18, wherein the assistant bus-bar module further comprises a positioning piece; the first main bus-bar defines a first cutout, and the second main bus-bar defines a second cutout; the first guiding piece is secured to the second assistant bus-bar and the positioning piece, the second guiding piece is secured to the positioning piece through the first cutout and the second cutout, and the first assistant bus-bar is located between the positioning piece and the second assistant bus-bar.

20. The power supply system of claim 18, wherein the first locking piece is electronically connected to the first power supply board, and the second locking piece is electronically connected to the second power supply board.
